(19) United States
(12) Patent Application Publication
(10) Pub. No.: US 2014/0279611 A1
(43) Pub. Date: Sep. 18, 2014

(54) HIGH ASSURANCE FEDERATED ATTRIBUTE MANAGEMENT

(71) Applicant: Eid Passport, Inc., Hillsboro, OR (US)

(72) Inventors: Christopher EVANS, Hillsboro, OR (US); Steve LARSON, Henderson, NV (US); James ROBELL, Beaverton, OR (US); Abrar AHMED, Tigard, OR (US)

(73) Assignee: Eid Passport, Inc., Hillsboro, OR (US)

(21) Appl. No.: 14/216,930

(22) Filed: Mar. 17, 2014

Related U.S. Application Data
(60) Provisional application No. 61/799,383, filed on Mar. 15, 2013.

(51) Int. Cl. G06Q 30/00

(52) U.S. Cl. CPC G06Q 30/018
USPC 705/317

(57) ABSTRACT

Methods, systems, and computer program products for managing attributes of a person are disclosed. The method may include receiving, by an electronic apparatus, identity data of a person, and receiving, by the electronic apparatus, one or more asserted attributes of the person. The method may additionally include storing, by the electronic apparatus and in an electronic database, the identity data of the person in association with the one or more asserted attributes of the person, and receiving, by the electronic apparatus, confirmation of the one or more asserted attributes based on information received from one or more publishers of the one or more asserted attributes. The method may further include associating, by the electronic apparatus, the confirmation with the one or more asserted attributes of the person, and storing, by the electronic apparatus and in the electronic database, an indication that the one or more asserted attributes are confirmed.

### CROSS-REFERENCE TO RELATED APPLICATIONS

This application claims the benefit of U.S. Provisional Patent Application Serial No. 61/799,383, which was filed on Mar. 15, 2013. The complete disclosure of the above application is hereby incorporated by reference for all purposes.

### BACKGROUND OF THE DISCLOSURE

Many different organizations are responsible for certifying capabilities or backgrounds of individuals. For example, different boards may certify, authorize, license, or approve identified individuals to practice physical therapy, nursing, dentistry, medicine, engineering, law, accounting, and other professions or to serve in defined capacities such as firefighting, law enforcement and first responder duties. Educational institutions may certify education received by an individual at the institution, and industry trade associations may certify individuals as meeting specified industry standards. Scouting and other youth and community organizations may certify that volunteers are screened and approved to be involved with the organization. Numerous other examples also exist. Such certifications may be considered examples of attributes of the individuals involved.

Persons who possess certifications must obtain certified or other official copies of issued documents evidencing the certifications, or must give a relying party (i.e., those who rely on the certifications) the authority to request confirmation of the certifications directly from the organizations. Such requests are made on an ad hoc basis for each certification needing confirmation.

Persons and organizations also need assurance that persons they are dealing with are the persons they hold themselves out to be, in addition to asserting that they possess certain certifications. Integrated circuit cards, also referred to as Smart Cards, coupled with a public key infrastructure (PKI) have been accepted as secure means for authenticating identity and providing interoperability with physical and logical access control systems.

### BRIEF SUMMARY OF THE DISCLOSURE

According to one embodiment, a method for managing attributes of a person may include receiving, by an electronic apparatus, identity data of a person, and receiving, by the electronic apparatus, one or more asserted attributes of the person. The method may additionally include storing, by the electronic apparatus and in an electronic database, the identity data of the person in association with the one or more asserted attributes of the person, and receiving, by the electronic apparatus, confirmation of the one or more asserted attributes based on information received from one or more publishers of the one or more asserted attributes. The method may further include associating, by the electronic apparatus, the confirmation with the one or more asserted attributes of the person, and storing, by the electronic apparatus and in the electronic database, an indication that the one or more asserted attributes are confirmed.

According to one embodiment, a computer system may include a processor and a memory. The computer system may additionally include a program comprising a plurality of instructions stored in the memory that are executed by the processor to receive identity data of a person, and receive one or more asserted attributes of the person. The plurality of instructions may additionally comprise instructions that are executed by the processor to store, in the memory, the identity data of the person in association with the one or more asserted attributes of the person, and receive confirmation of the one or more asserted attributes based on information received from one or more publishers of the one or more asserted attributes. The plurality of instructions may further comprise instructions that are executed by the processor to associate the confirmation with the one or more asserted attributes of the person, and store, in the memory, an indication that the one or more asserted attributes are confirmed.

According to one embodiment, a computer program product for managing attributes of a person may include at least one computer readable storage medium having computer readable program instructions embodied therewith. The computer readable program instructions, when read by a processor, may be configured to receive identity data of a person, and receive one or more asserted attributes of the person. The computer readable program instructions, when read by the processor, may be additionally configured to store, in an electronic database, the identity data of the person in association with the one or more asserted attributes of the person, and receive confirmation of the one or more asserted attributes based on information received from one or more publishers of the one or more asserted attributes. The computer readable program instructions, when read by a processor, may be further configured to associate the confirmation with the one or more asserted attributes of the person, and store, in the electronic database, an indication that the one or more asserted attributes are confirmed.

### BRIEF DESCRIPTION OF THE DRAWINGS

FIG. 1 depicts an example of a computer system configured to manage attributes.

FIG. 2 depicts an example of a network including a computer system of FIG. 1 configured to provide attribute management.

FIG. 3 is an example of a high-assurance federated attribute management system that may be provided by the computer system of FIG. 1 and/or the network of FIG. 2.

FIG. 4 is a flowchart showing an example of a method of enrolling a person as a participant in an attribute management system.

FIG. 5 is a flowchart showing an example of a method of adding and certifying a new attribute of a participant.

FIG. 6 is a flowchart showing an example of a method of accessing a participant's account using an electronic token reader.

FIG. 7 is a flowchart showing an example of a method of enrolling a relying party and creating a new verification program.

FIG. 8 is a flowchart showing an example of a method of verifying attributes of a participant.

FIG. 9 is a flowchart showing an example of a method of verifying attributes of a participant using an electronic token reader.

### DETAILED DESCRIPTION OF VARIOUS EMBODIMENTS

As will be appreciated by one skilled in the art, aspects of the present invention may be embodied as a system, method or computer program product. Accordingly, aspects of the present invention may take the form of an entirely hardware embodiment, or an embodiment combining software (including firmware, resident software, micro-code, etc.) and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium, such as an electronic, magnetic, optical, electromagnetic, infrared, or semiconductor system, apparatus, or device, or any suitable combination of the foregoing. More specific examples of the computer readable storage medium would include a portable computer diskette, a hard disk, solid-state drive, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a local computer (such as a local server), partly on the local computer and partly on a remote computer (such as a cloud-based or Internet-based or Internet-accessible server or other computer), or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of attribute management are described below with reference to block diagrams of methods, apparatus (systems) and computer program products according to exemplary embodiments. It will be understood that each block of the flowchart illustrations and/or block diagrams, combinations of blocks in the flowchart illustrations and/or block diagrams, or described below with or without corresponding illustration in the figures, can be implemented on computers by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the description and/or block diagram block or blocks.

Although this disclosure includes a detailed description of a computing environment, implementation of the teachings recited herein are not limited to the described and illustrated computing environment. Rather, embodiments may be implemented in conjunction with any other type or configuration of computing environment now known or later developed, including a distributed environment like clusters of nodes in a network wherein a node represents an independently operating system, a system contained within a dedicated network, or a network including a wide area network, and resources of an operating system may exist in part or wholly within one or more cloud-based resources.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

The detailed description that follows is presented largely in terms of algorithms, and symbolic representations of operation of data bits within a computer memory. These algorithmic descriptions and representations are the means used by those skilled in the data processing arts to most effectively convey the substance of their work to others skilled in the art. It may be preferred to implement and describe a program as various interconnected distinct software modules or features. This is not necessary, as software, firmware, and hardware may be configured many different ways, and may be aggregated into a single processor and program with unclear boundaries.

In the present case, the operations are machine operations performed in conjunction with a human operator. Useful machines for performing the operations disclosed include general purpose digital computers, microprocessors, or other similar devices.

The present disclosure also relates to apparatus for performing these operations. This apparatus may be specially constructed for the required purposes or it may comprise a general-purpose computer selectively activated or reconfigured by a computer program stored in the computer or other apparatus. In particular, various general purpose machines may be used with programs in accordance with the teachings herein, or it may prove more convenient to construct more specialized apparatus to perform the required method steps. The required structure for a variety of these machines will appear from the description given below.

It should be clear to a person skilled in the art that a program embodying the disclosed methods need not reside in a single memory, or even a single machine. Various portions, modules or features of it can reside in separate memories, or even separate machines. The separate machines may be connected directly, or through a network, such as a local access network (LAN), or a global network, such as what is presently known as the Internet. Similarly, the users need not be co-located with each other, but each only with a machine that houses a portion of the program.

Referring now to FIG. 1, a schematic is shown of an example of a computer system/server 10, which may be a cloud computing node 12. Computer system 10 is only one example of a suitable computing environment and is not intended to suggest any limitation as to the scope of use or functionality of embodiments an attribute management system. Regardless, computer system/server 10 may be capable of being implemented and/or performing any of the functionality described below.

Computer system/server 10 may be operational with numerous other general purpose or special purpose computing system environments or configurations. Examples of well-known computing systems, environments, and/or configurations that may be suitable for use with computer system/server 10 include personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 10 may be described in the general context of computer system executable instructions, such as program modules, being executed by a computer system. Generally, program modules may include routines, programs, objects, components, logic, data structures, and so on that perform particular tasks or implement particular abstract data types. Computer system/server 10 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 10 in cloud computing node 12 is shown in the form of a general-purpose computing device. The components of computer system/server 10 may include one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. Computer system/server 10 typically includes a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system/server 10 may further include other removable/non-removable, volatile/non-volatile computer system storage media. By way of example only, storage system 34 can be provided for reading from and writing to a non-removable, non-volatile magnetic media (not shown separately and typically called a “hard drive”) or solid-state media. System memory 28 may also include a magnetic disk drive for reading from and writing to a removable, non-volatile magnetic disk (e.g., a “floppy disk”), removable solid-state or flash drive, and an optical disk drive for reading from or writing to a removable, non-volatile optical disk such as a CD-ROM, DVD-ROM or other optical media included in the system memory. In such instances, each can be connected to bus 18 by one or more data media interfaces.

As will be further depicted and described below, memory 28 may include at least one program product having a set of (e.g., at least one) program modules that are configured to carry out the functions of embodiments of the invention. Program/utility 40, having a set of (at least one) program modules 42, may be stored in memory 28 by way of example, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of attribute management as described herein. Program modules 42 may be stored in a kernel of the operating system.

Computer system/server 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via input/output (I/O) interfaces 22. Still yet, computer system/server 10 can communicate with one or more networks such as a local area network (LAN), a general wide area network (WAN), and/or a public network (e.g., the Internet) via network adapter 20. As depicted, network adapter 20 communicates with the other components of computer system/server 10 via bus 18. Although not shown, other hardware and/or software components could be used in conjunction with computer system/server 10.

Examples include: microcode, device drivers, redundant processing units, external disk drive arrays, RAID systems, tape drives, and data archival storage systems, etc. Computer system 10 may sometimes be referred to as an “electronic apparatus.”

Referring now to FIG. 2, an illustrative cloud computing environment 50 is depicted as an example of a network. As shown, cloud computing environment 50 comprises one or more cloud computing nodes 12 with which local computing devices used by cloud consumers, such as, for example, personal digital assistant (PDA), smart phone, other smart or mobile computing device, or cellular telephone 54A, desktop computer 54B, laptop computer 54C, and/or automobile computer system 54N may communicate. Nodes 12 may communicate with one another. They may be grouped (not shown) physically or virtually, in one or more networks, such as Private, Community, Public, or Hybrid clouds or networks as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 12 and cloud computing environment 50 can communicate with any type of computerized device over any type of network and/or network addressable connection (e.g., using a web browser).

Currently when individuals are trying to prove attributes about themselves, they utilize a different mechanism to prove each attribute. For instance, to prove the attribute of obtaining a physical therapy license, one receives a license from the licensing body for that state. This licensure is proved via a piece of paper that has the name of the individual and a license number. In order for patients who require services to prove the physical therapist is certified they must look at the paper license posted in the clinic and also look up the name on the state board website. The person typically accepts such a license at face value, as it is difficult or inconvenient to prove with a high level of certainty that the license is valid or that the person is in fact the person identified on the license.

Computer system 10 and cloud computing environment 50 may be configured as a high assurance federated attribute management system 60, an example of which is illustrated in FIG. 3. Persons may enroll in the attribute management system by setting up identities. Other authorized bodies as attribute providers may then publish attributes associated to those identities. A set of standards-based identifiers for attributes (e.g., state-issued identification cards or licenses) may be published for compiling attributes.

The example of an attribute management system shown in FIG. 3 may include one or more of the components discussed below.

### Attribute Manager 62

Attribute manager 62 (also may be referred to as an “attribute clearing house” or “attribute compiler”) may enroll persons or participants 64 via an identity enrollment process, accessed via identity enrollment communication path 65 and through an identity enrollment portal 66, and/or may maintain an electronic central attribute repository or electronic data store 68 where enrolled persons may manage their set of claimed attributes via attributes management communication path 67 and through an attributes management portal 70. For example, enrolled persons may manage the content and use of attributes related to their identity, such as how her, his, or its attributes are published. An enrolled person may state which attributes are public and which ones are not. Central attribute repository 68 may sometimes be referred to as an “electronic database.”

Attribute publishers may provide the attribute manager with attributes that are associated with enrolled persons. Relying parties may leverage the attribute manager services to query attributes.

In this example, the attribute manager may maintain a store of enrollee records and provides interaction between enrolled persons, attribute publishers, and relying parties and may maintain a secure and trusted communication relationship between these entities. The attribute manager thus is the manager and operator of the aggregated attribute management system and is the holder of attributes received from participating attribute providers, and may perform and/or be responsible for the following functions:

manages identities of persons associated with the attribute manager,

manages attribute publishers associated with the attribute manager,

manages security and permissions of attribute publication by specific publishers associated with the attribute manager,

manages a list of defined attributes, and/or

manages security around the release of specific attributes of an enrolled person associated with the attribute manager.

### Identity Enrollment Portal 66

Identity enrollment portal 66 may provide an enrolling person 64 through an identity enrollment interface 69 to enroll with attribute manager 62 or an agent of the attribute manager.

The identity enrollment interface may be provided by a personal computer, a personal digital assistant, a wireless device, a cellular phone, an internet appliance, a smart phone, a tablet, a media center, an attribute manager kiosk, and the like. The identity enrollment portal may be provided by a website, an application (such as for a smart phone and/or tablet), a software adapter, an automated phone system, etc. that is configured to request and/or receive identity data or information from the enrolling person and provide that data to the attribute manager. As used herein “identity data” refers to any data or information that can uniquely identify a person. For example, when person 64 is an individual, identity data may include biographic information (e.g., name, address, phone number, social security number, birth date, company's stock symbol, etc.) and/or biometric information (e.g., fingerprints, face recognition, DNA, hand and palm geometry, iris recognition, odor/scent, etc.).

In some examples, the identity enrollment portal may allow person 64 to scan and/or upload identity documentation and/or other identity information. For example, when person 64 is an individual, examples of identity documentation include a driver's license, ID card, passport, permanent residence card, alien registration receipt card, employment authorization document, voter's registration card, military card, school record, report card, clinic, doctor, or hospital record, day-care or nursery school record, Social Security Account Number card, birth certificate, tax documents, utility bills, and/or other suitable documents. Alternatively, when person 64 is a company, the identity documentation may include articles of incorporation, bylaws, tax documents, utility bills, State issued documents, and/or other suitable documents. Alternatively, or additionally, the identity enrollment portal may provide a mailing address for the person to send the identity documentation.

### Attribute Management Portal 70

Attribute management portal 70 may provide person 64 through an attribute management interface 71 to manage attributes stored in attribute manager 62, such as in attribute data store 68.

The attribute management interface may be provided by a personal computer, a personal digital assistant, a wireless device, a cellular phone, an internet appliance, a smart phone, a tablet, a media center, an attribute manager kiosk, and the like. The attribute management portal may be provided by a website, an application (such as for a smart phone and/or tablet), a software adapter, an automated phone system, etc. Attribute management portal 70 may allow a person to add, delete, and/or modify attribute(s) stored in attribute manager 62. In some examples, identity enrollment interface 69 and attribute management interface 71 may be a single interface, which may be referred to as an “identity and attribute management interface.” Additionally, identity enrollment portal 66 and attribute management portal 70 may be a single portal (such as, for example, an “identity and attribute management portal”).

The attribute management portal may allow person 64 to scan and/or upload attribute documentation. The attribute documentation may include any documentation that certifies one or more attributes. For example, when person 64 is an individual, examples of attribute documentation include diplomas, certificates, membership cards, etc. In some examples when an identity token is used (further discussed below), person 64 may use an electronic token reader 73 to provide information via token reader communication path 75 to the attribute management portal. The token reader may include any suitable structure configured to read the identity token and provide read (or scanned) information to the attribute manager via the attribute management portal.

### Identity Token 72

In some examples, attribute management system 60 may include an identity token 72, which may take the form of a standards-based high assurance identity token or other suitable identity token, coupled with a centralized cloud based service providing federated attribute management. In one example, identity authentication and federated certifications management are coupled with smart card technology.

The identity token may be issued to a person 64 who has undergone a process of proving the person is in fact who the person says she, he, or it is. The person initiates this process, for example, by enrolling with attribute manager 62 or an agent of the attribute manager via identity enrollment portal 66, interface, or other means (collectively referred to herein as a “portal”). For example, driven by the issuance of Homeland Security Presidential Directive 12 (HSPD-12) in 2004, the U.S. Federal Government has invested significant effort and resources in implementing robust, interoperable credentialing processes and technologies for issuing identity credentials to government employees and contractors. The resulting standard, Federal Information Processing Standard (FIPS) 201, Personal Identity Verification (PIV) of Federal Employees and Contractors, provides a framework of the policies, processes, and technology that may be used to establish a strong, comprehensive program of credentialing. Likewise, through the issuance by the Federal CIO Council in 2009 of the Personal Identity Verification Interoperability for Non-Federal Issuers, guidance exists for non-federal issuers of identity credentials to achieve interoperability with Federal government PIV systems. Identity credentials issued under frameworks such as these may be considered examples of high-assurance identity tokens.

Once the person provides appropriate proof of identity, the person may be issued identity token 72. Identity token 72 may be in any suitable form that provides identity authentication, including physical, digital, electronic or other form. Examples include an integrated circuit chip (ICC), or other appropriate token, such as a phone subscriber identification module (SIM) card or secure digital (SD) card. Use of a secure ICC in this scenario supports identity authentication and reduces the potential of tampering. Existing electronic standards may be used to allow for the assertion of the person's identity against the identity token.

For example, the attribute manager may initiate the creation of the identity token and provide the identity token to person 64 via path 77, which may be a digital or electronic path (such as when the identity token is a virtual token) or a physical path (such as when the identity token is a physical card that is delivered to the person). The identity token may be activated by person 64 and that activated token may allow the person to authenticate her, his, or its identity to third parties with a need for confirmation of the attributes. Such third parties are referred to as “relying parties.” Person 64 may provide the identity token to a relying party via path 79, which may be a digital/electronic path or a physical path.

### Attribute Publishing Portal 76

Attribute publishers 74 are organizations that attest whether or not someone has an attribute. For instance, a state medical board may publish an attribute that states whether or not an individual has specified medical certifications. An attribute publisher thus may be an organization that publishes, into the attribute manager, agreed upon attributes associated with an enrolled person. Attribute publishers may be limited in the attributes they may publish.

Attribute publishers 74 may interact with attribute manager 62 via an attribute publishing portal 76 through attribute publishing communication path 83. The attribute publishing portal may provide attribute publishers 74 through an attribute publisher interface 81 the ability to certify and/or confirm a person's attribute(s). The attribute publisher interface may be provided by a personal computer, a personal digital assistant, a wireless device, a cellular phone, an internet appliance, a smart phone, a tablet, a media center, an attribute manager kiosk, and the like. Attribute publishing portal 76 may be provided by a website, an application (such as for a smart phone and/or tablet), a software adapter, an automated phone system, etc. Attribute publishing portal 76 may allow the attribute publisher to certify and/or confirm one or more attributes of person 64.

### Attribute Publisher System 78

Attribute publishers 74 may have an attribute publisher system 78 to manage its publication of attributes. The attribute publisher system may include an attribute publisher data store or database 80 that may store attribute data, such as lists of persons with particular attributes.

In some examples, the attribute publisher system may interact with attribute manager 62 via attribute publisher system communication path 85 to attribute publishing portal 76. When the attribute publisher system is connected to the attribute manager, attribute publishing portal 76 may be in the form of a software adapter or application that is executed at the attribute publisher system and has access to the attribute publisher data store.

In order to maintain up to date attributes in the attribute manager's aggregated attribute data store, synchronization services may be provided to ensure the attributes remain up to date. An attribute publisher synchronizer 82 (or attribute publisher synchronization module) resident in the attribute publisher's system may provide for ongoing or periodic updating of attributes to the attribute manager or the attribute manager may query the attribute publisher system for updates of current managed identities.

### Attribute Confirmation Portal 84

A relying party 86 is any person that or who relies on the attribute manager to confirm a claim that is being made. In this example, person 64 who has an attribute that is the subject of the claim may assert that claim to relying party 86 electronically or otherwise prior to the confirmation request being made. Relying parties then may query attribute manager 62 via an attribute confirmation portal 84 through attribute confirmation communication path 87. For example, a relying party may access attribute confirmation portal 84 through relying party interface 88 to receive attribute information on specific persons. The relying party interface may be provided by a personal computer, a personal digital assistant, a wireless device, a cellular phone, an internet appliance, a smart phone, a tablet, a media center, an attribute manager kiosk, and the like. Attribute confirmation portal 85 may be provided by a website, an application (such as for a smart phone and/or tablet), a software adapter, an automated phone system, etc.

In some examples when identity token 72 is used, person 64 may provide the identity token to the relying party. The relying party may scan or read the identity token and/or input information from that token. The person in each case may determine if the relying party has permission to actually query the attribute. For example, the relying party may use an electronic token reader 89 to provide information from the identity token (such as identity and/or attribute information of person 64) to the attribute confirmation portal via a token reader communication path 90. The token reader may include any suitable structure configured to read the identity token and provide read (or scanned) information to the attribute manager via the attribute confirmation portal. Alternatively, the person may provide information (such as information on her, his, or its identity token) to the relying party that then provides the information to attribute confirmation portal 84 to request confirmation of an attribute claim of the person.

The various interfaces, communication paths, and portals illustrated, the attribute manager, and the attribute management system may be provided by a computer system or computer systems accessible over a local or wide area network, such as the World Wide Web or Internet. The interfaces, communication paths, and portals may be provided by means including using dedicated systems or may be accessible by means including websites using local computers or work stations. The communication paths may include wired and/or wireless connections to facilitate the exchange of analog and/or digital data, which may include connections to one or more networks, such as the Internet and other types of communication networks. One or more of the communication paths also may be referred to as “data network links.” A token reader may be a scanning device, whether stand-alone, hand-held, and/or integrated into a dedicated interface.

### An Example

A given individual decides to practice physical therapy in the State of Oregon.

The individual goes through the identity enrollment portal to initiate the identity proofing process with the attribute manager or agent functioning as a high assurance identity provider. The individual is issued an identity credential that provides high assurance assertion of the individual's identity. The individual then may enroll the identity credential into the attribute manager to manage the individual's identity from that point forward. This may include the attribute that evidences the individual's license to practice physical therapy in Oregon, and it also may include any number of additional attributes, which may or may not be related, such as educational degree, scuba diving certification, and automobile association membership. During the process of becoming licensed to practice physical therapy by the Oregon state licensing board the individual associates his or her high assurance identity credential with the state licensing board. The board then publishes his or her license status into the attribute manager.

One or more relying parties, which may or may not be related, then may use the one or more attributes associated with the individual's identity to ensure the individual is authorized to participate in an activity or perform a transaction or function such as practicing physical therapy in Oregon. In the example of a physical therapist, the identity credential may be used to assert the individual's identity during signing documents and ensure that the individual is currently a licensed physical therapist. For example, patients may scan the therapist's identity credential to confirm that the therapist is permitted to practice in the state of Oregon. Hiring entities that require the Physical Therapy license for Oregon also may electronically read the therapist's identity credential to ensure the therapist has the proper licenses prior to hiring.

The identity attribute management system described above thus may provide a standard mechanism for licensing and certification bodies to publish attributes and for relying parties to check those attributes. Such a system benefits both the user of the system and the person who attests the attributes of the person by, for example, reducing fraud. In the example above, the patient may electronically validate the identity and attribute or attributes of the physical therapist through the use of a computer system that communicates to an attribute manager to confirm the claimed attribute(s).

There are numerous attributes that are managed by different disparate entities that use different standards, making attribute assurance difficult. Coupling an identity token, a federated attribute publisher maintaining a database of compiled or aggregated attributes and identities, and a centralized attribute service as provided in this high assurance attribute management system increases the reliability of such attributes and allows for queries of attributes through a central attribute manager.

Referring now to FIG. 4, an example of a method 100 of enrolling a participant 102 with attribute manager 104 is shown. The participant may enroll with the attribute manager at 106. For example, the participant may access the clearance house via the identity enrollment portal, such as over the Internet, over the phone, or at an attribute manager kiosk. The participant may be required to provide any suitable information to be enrolled, such as name, contact information, etc. The attribute manager may receive the enrollment data at 108.

The participant may provide identity data at 110 via the identity enrollment portal. For example, the participant may be required to provide identity data that would establish the identity of the participant (or determine if the participant is who they declare they are). In some examples, the requested identity data may be a knowledge-based assessment in the form of “out-of-wallet” questions, or questions that cannot be answered by the contents of a participant's wallet, such as how many bedrooms in the participant's house, how much was the last deposit made into the participant's checking account, etc. The attribute manager may receive and store the identity data in its database at 112. In some examples, the attribute manager may start a new record in its data store or database for the participant and store on the enrollment and/or identity data in that record.

After receiving the identity data, the attribute manager may determine at 114 if enough identity data was provided for identity proofing (or identity validation) of the participant. In some examples, the participant must answer all or most questions or queries correctly for identity proofing. The identity proofing process may be based on one or more suitable algorithms. If the attribute manager determines that the participant's identity was validated at 116 (such as when a sufficient number of questions were answered correctly by the participant), then the attribute manager may associate the identity proofing with the stored identity data at 118. The attribute manager may store the identity proofing (or an indication of the identity proofing) with the identity data in its data store or database and/or notify the participant that an account has been created at 132. The participant may receive notification of creation of the account at 134.

If the attribute manager determines that the participant's identity was not validated at 120 (such as when an insufficient number of questions were answered correctly by the participant), then the attribute manager may inform the participant and/or request identity documentation from the participant at 122. The attribute manager may request the participant to upload, scan, e-mail, fax, and/or mail any suitable identity documentation. The participant may provide the requested identity documentation at 123. In some examples, the participant may upload the identity documents and send the documents to the attribute manager via the identity enrollment portal. In other examples, one or more individuals associated with the attribute manager may upload the received identity documents (such as documents sent by mail) into the attribute manager, such as into the attribute manager data store.

The attribute manager may review the received identity documentation at 124, such as to determine the authenticity of the identity documentation. For example, the attribute manager may detect if there are any erasures and/or alterations, and/or may compare one or more characteristics of the received identity documentation against the corresponding characteristics of a genuine document. In some examples, the attribute manager may electronically and/or automatically perform the above detection and/or comparison steps in response to receiving the identity documentation from the participant. In other examples, one or more individuals associated with the attribute manager may perform the review and input results of that review into the attribute manager, such as into the attribute manager data store. Based on the review, the attribute manager may determine whether the identity documentation is authentic at 125.

If the attribute manager determines that the identity documentation is authentic and thus the identity of the participant was proven at 126, then the attribute manager may associate the proofing with the stored identity data at 118. If the attribute manager determines that the identity documentation is not authentic and thus the identity of the participant was not proven at 128, then the participant may be notified that the identity documentation was rejected at 130. In some examples, the participant may be provided the opportunity to submit other identity documentation. In those examples, the attribute manager may repeat the above review process for the additional identity documentation.

Although FIG. 4 shows identity proofing via two paths or modes of authentication or identity proofing, method 100 may alternatively include only one of those modes or may require both modes even if when there is successful identity proofing after the first mode. For example, method 100 may require that the participant prove their identity only via the online knowledge-based assessment without the option of providing identity documentation. Alternatively, the participant may always be required to provide identity documentation regardless of whether the participant answers a sufficient number of questions correctly under the online knowledge-based assessment.

In some examples, the attribute manager may create (or initiate the creation of) an identity token for the participant based on the stored identity data and send that token to the participant at 136. The identity token may be a Smart Card, a virtual card, and/or other suitable cards as described above. When the identity token is a physical card, the identity token may be mailed to the participant. When the identity token is a virtual card, the card or a link to activate the card may be e-mailed to the participant. The participant may receive the identity token (or the link to the token) at 138. The participant may activate the received token at 140. For example, the participant may activate the token via a website of the attribute manager, via an attribute manager kiosk, and/or via the phone. In some examples, the participant may use a token reader to activate the token and/or may provide information from the token to the website, kiosk, or phone. Activating the identity token may allow the participant to use the identity token to attest to their attributes and/or to manage attributes stored in the attribute manager, as further discussed below.

Referring now to FIG. 5, an example of a method 150 of adding and certifying new attribute(s) of a participant 152 is shown. Method 150 may include one or more steps associated with participant 152, at least one attribute publisher 154, and/or an attribute manager 156. Participant 152 may access their clearance house account via the attribute management portal, such as over the Internet, over the phone, or at an attribute manager kiosk at 158. When an identity token is used, participant 152 may use a token reader to access the account (further discussed below).

Upon accessing the account, the participant may add new attribute(s) (or new asserted attribute(s)) to their account at 160. As part of adding a new asserted attribute, the participant may be required by the attribute manager to provide other information, such as the name of the attribute publisher, contact information for the attribute publisher, date attribute was earned and/or received from the attribute publisher, and/or any alphanumeric and/or other information that identifies the attribute (such as registration number, membership number, etc.).

The participant may upload documentation that attests to the new attribute at 162. The participant may upload any suitable attribute documentation, such as certificates, transcripts, and/or other documents that attest that the participant possesses the new attribute. The participant may scan copies of the attribute documentation, which may then be automatically sent to the attribute manager via the attribute management portal for review at the attribute manager. Alternatively, or additionally, the participant may be directed to e-mail, fax, and/or mail copies of the attribute documentation to the attribute manager.

The attribute manager may receive the new attribute and the uploaded attribute documentation at 164. When the documentation is mailed, one or more individuals associated with the attribute manager may upload the documentation into the attribute manager, such as into the attribute manager database. Additionally, the attribute manager may store the received new attribute in association with the identity data of the person (or vice-versa) in the database at 166. The attribute manager may review the attribute documentation at 168. For example, the attribute manager may review the attribute documentation to determine if the documentation is sufficient to attest to the new attribute at 170. For example, the attribute manager may determine if the name of the participant is on the attribute documentation, the appropriate attribute publisher is identified on the attribute documentation, the appropriate date(s) are identified on the attribute documentation, etc. In some examples, the review may be performed electronically by the attribute manager scanning the attribute documents for the above information, extracting information from the scanned documents, and comparing the extracted information with the new attribute. In other examples, one or more individuals associated with the attribute manager may perform the above review and input the results of the review into the attribute manager, such as into the attribute manager database. The attribute manager (and/or individuals associated with the attribute manager) may additionally perform a review for the authenticity of the attribute documentation, such as by using one or more of the processes described above for the identity documentation.

If the document is sufficient to attest to the new attribute at 172, then the attribute manager may query the attribute publisher and/or attribute publisher system at 174 for authentication of the documentation and/or confirmation of the new attribute. For example, the attribute manager may send an electronic message to the attribute publisher and/or attribute publisher system requesting confirmation that the person has the new attribute. Alternatively, the attribute publisher system may include a synchronizer module that allows the attribute manager to query the attribute publisher system. In some examples, the attribute manager may be configured to access the attribute publisher data store to determine if the person has the new attribute.

In other examples, one or more individuals associated with the attribute manager may contact the attribute publisher, such as via phone, e-mail, etc., and request confirmation of the new attribute. Alternatively, those individuals may conduct a search at the attribute publisher's data store (or repository) to provide confirmation of the new attribute. The above individuals may input results of contacting the attribute publisher and/or conducting the search into the attribute manager, such as into the attribute manager database.

If the document is not sufficient to attest to the new attribute at 175, then the attribute manager may notify the participant at 176. In some examples, the attribute manager may request additional documentation from the participant and conduct the above review steps on that documentation.

The attribute publisher (or attribute publisher system) may receive the query and provide a response to the attribute manager regarding the new attribute in response to the query at 177. If the person has the new attribute, then the attribute publisher or attribute publisher system would respond to the query confirming that the person has the new attribute. If, however, the person does not have the new attribute, then the attribute publisher or attribute publisher system would respond to the query stating that the person does not have the new attribute.

The attribute manager may receive information regarding the new attribute at 178, such as in response to the query. If the new attribute was confirmed at 182, then the attribute manager may associate the received confirmation with the new attribute at 183. Additionally, the attribute manager may store the confirmation (or an indication of the confirmation) with the new attribute in its database at 184. Moreover, the attribute manager may begin a monitoring program for the new attribute at 185. If, however, the new attribute was not confirmed at 186, then the attribute manager may notify the participant at 187.

The monitoring program may be configured to continuously or periodically query the attribute publisher (or attribute publisher system) regarding whether the person continues to have or possess the new attribute. For example, monitoring may be by real-time updates or interval-based electronic updates. The attribute publisher may receive the queries and may provide information (such as a confirmation) in response to the queries at 188. In some examples, the attribute manager may access the data store of the attribute publisher system to determine if the person still has the new attribute. In other examples, the new attribute may not be monitored.

Referring now to FIG. 6, an example of a method 200 is shown of accessing an account at an attribute manager 202 of a participant 204 when the participant has an identity token provided by the attribute manager. The participant may access the attribute management portal, such as via the Internet, phone, or attribute manager kiosk, at 206. The participant may read the identity token using a token reader at 208.

The attribute manager may receive information regarding the person from reading the identity token at 210. The read information may include any suitable information to identify the participant in the attribute manager data store, such as identity information, attribute information, alphanumeric identifiers, etc. The attribute manager may associate the received information with the stored identity data in the data store at 212. Once associated, the attribute manager may provide or allow access to the participant's account at 214. The participant may then access his, her, or its account, such as to manage attributes, at 216. For example, the participant may add new attribute(s), delete stored attribute(s), modify stored attribute(s), etc.

Referring now to FIG. 7, an example of a method 250 of enrolling a relying party 252 with an attribute manager 254 and starting a new verification program is shown. Relying party 252 may provide information for a new enrollment account at 256. The enrollment information may include identity information, contact information, and/or other suitable information regarding the relying party. The attribute manager may receive the enrollment information and create a new enrollment account at 258.

The relying party also may provide information for a new verification program at 260. The program information may include a list of potential enrollees, attribute(s) to be confirmed, frequency of updates for confirming the attribute(s) (e.g., real-time, interval-based, etc.), and/or other suitable information. The attribute manager may receive the program information and validate the new verification program at 262. Validation of the new verification program may include checking on whether the relying party has valid reasons to request confirmation of the attributes. For example, a potential employer of a fire safety professional may have valid reasons to request the confirmation of any asserted professional certifications but may not have valid reasons to request confirmation of non-professional attributes, such as fishing licenses, etc. If the new verification program cannot be validated, the attribute manager (or an individual associated with the attribute manager) may contact the relying party and request additional information, such as reasons why particular attributes are included in the new verification program.

Once the new verification program is validated, the new verification program may be created at 264. The attribute manager may then notify the relying party of the creation of the new verification program. The relying party may then request persons to enroll in the created verification program via any suitable method(s).

Referring now to FIG. 8, an example of a method 300 of verifying attributes of a participant 302 is shown. The method may include one or more steps associated with participant 302, a relying party 304, and/or an attribute manager 306. The participant may access his, her, or its attribute manager account through the attribute management portal (and/or any suitable portal) at 308. The participant may enroll in a verification program at 310, such as in response to a request by relying party 304 that is interested in confirming one or more attributes of the participant.

Relying party may receive the enrollment request of the participant at 312. For example, the participant may inform the relying party that he, she, or it has enrolled and the relying party may then access the verification program and the enrollment request via the attribute confirmation portal of the attribute manager. Alternatively, the attribute manager may send the relying party a notification (such as an electronic message) that a participant has submitted an enrollment request for the relying party's verification program. The attribute manager may require the relying party to determine whether the participant should be permitted to participate in the verification program at 314.

If the relying party determines that the participant should be permitted to participate in its verification program at 316, then the relying party may request that the participant be included in the verification program at 318. If, however, the relying party determines that the participant should not be permitted to participate in its verification program at 320, then the relying party may notify the participant at 322. Alternatively, the attribute manager may send a notification (such as an electronic message) to the participant regarding his, her, or its exclusion from the verification program.

The attribute manager may receive the request to include a participant in the verification program at 324 and associate the request with stored identity data in the attribute manager data store 326. For example, enrollment information provided by the participant may be associated with the stored identity data of that participant, such as to identify the proper record(s) in the data store to access. The attribute manager may verify the attribute(s) of the participant requested in the verification program at 328. For example, the attribute manager may determine from its data store whether the attributes requested in the verification program have been confirmed. In some examples, the attributes in the data store will have an indication that such attributes have been confirmed. The attribute manager may send a communication regarding the attributes to the relying party at 330. The communication may be in the form of an electronic message that provides details of the confirmation, provides a link to access the verification program through the attribute confirmation portal, or that requests that the relying party access the verification program through the attribute confirmation portal.

The relying party may receive the communication at 332 and may perform one or more other actions in response to the communication. For example, if the attribute(s) of the participant was confirmed, then the relying party may include the participant in its other programs and/or systems or bind the participant to those programs and/or systems.

In some examples, the attribute manager may monitor the attribute(s) and provide communications to the relying party regarding the attribute(s). In some examples, the monitoring details may be defined by the relying party's verification program. The monitoring may be by real-time updates (e.g., the attribute manager sends a communication to the relying party when there is a change in the attribute, such as when the person no longer has the attribute), or interval-based electronic updates (e.g., the attribute manager sends a periodic communication to the relying party regarding the attribute, whether there is a change or not).

Referring now to FIG. 9, an example of a method 350 of verifying attribute(s) of a participant 352 using a token reader, such as when the participant has an identity token. The method may include one or more steps associated with participant 352, a relying party 354, and an attribute manager 356. The participant may provide their identity token to the relying party at 358, such as in response to a relying party's query regarding the one or more asserted attributes of the participant.

The relying party may receive the identity token at 360 and may access the attribute manager via the attribute confirmation portal at 362. In some examples, the relying party may access the appropriate verification program through the attribute confirmation portal. Additionally, the relying party may read the identity token using a token reader at 364. In some examples, the verification program may prompt the relying party to read the identity token of a permitted participant using a token reader. The relying party may request information regarding attribute(s) of the participant at 366. In some examples, the attribute(s) would have been pre-selected by the relying party for the verification program so the request at 366 may simply be incorporated in reading the identity token of the participant. In other words, reading the identity token with the token reader may include a request to confirm the attribute(s) that are identified in the verification program.

The attribute manager may receive the read identity token information at 368 and receive the request information regarding attribute(s) at 370. As discussed above, the attribute manager may associate the read identity token information as implicitly including a request to confirm the attribute(s) of the person identified in the verification program. The attribute manager may associate the read identity token information and/or information request with identity data of the person stored in the data store at 372, such as to identify the proper record to access, and then confirm the attribute(s) at 374. In some examples, the attribute manager may search for an indication in its database of that the attribute(s) identified in the verification program has been confirmed for the person. The attribute manager may send a communication to the relying party regarding the results of the verification at 376. The communication may be in the form of an electronic message that provides details of the confirmation, provides a link to access the verification program through the attribute confirmation portal, or that requests that the relying party access the verification program through the attribute confirmation portal.

The relying party may receive the communication at 378 and may perform one or more other actions in response to the communication. For example, as discussed above, if the attribute(s) of the participant were confirmed, then the relying party may include the participant in its other programs and/or systems or bind the participant to those programs and/or systems. In some examples, the attribute manager may monitor the attribute(s) and provide communications to the relying party regarding the attribute(s). In some examples, the monitoring details may be defined by the relying party's verification program. As discussed above, the monitoring may be by real-time updates or interval-based electronic updates.

Other examples of the above methods and/or flowcharts may add, omit, and/or modify one or more steps. The above description is intended to be illustrative, and not restrictive. Many other embodiments will be apparent to those of skill in the art upon reviewing the above description. This disclosure thus may include one or more independent or interdependent inventions directed to various combinations of features, functions, elements and/or properties. Such variations, whether they are directed to different combinations or directed to the same combinations, whether different, broader, narrower or equal in scope, are also regarded as included within the subject matter of the present disclosure.

What is claimed is:

1. A method of managing attributes of a person, comprising:
receiving, by an electronic apparatus, identity data of a person;
receiving, by the electronic apparatus, one or more asserted attributes of the person;
storing, by the electronic apparatus and in an electronic database, the identity data of the person in association with the one or more asserted attributes of the person;
receiving, by the electronic apparatus, confirmation of the one or more asserted attributes based on information received from one or more publishers of the one or more asserted attributes;
associating, by the electronic apparatus, the confirmation with the one or more asserted attributes of the person; and
storing, by the electronic apparatus and in the electronic database, an indication that the one or more asserted attributes are confirmed.

2. The method of claim 1, further comprising:
receiving, by the electronic apparatus and from a relying party using a data network link, a request to confirm at least one asserted attribute of the person;
associating, by the electronic apparatus, the request with the stored identity data of the person;
determining, by the electronic apparatus and from the electronic database, whether the at least one asserted attribute is a confirmed attribute of the person; and
sending, by the electronic apparatus and to the relying party using the data network link, a communication regarding whether the at least one asserted attribute is a confirmed attribute of the person.

3. The method of claim 2, further comprising initiating, by the electronic apparatus, the creation of an identity token for the person based on the stored identity data, and wherein receiving a request to confirm at least one asserted attribute of the person includes receiving, by the electronic apparatus, information regarding identity of the person from reading the identity token with an electronic token reader.

4. The method of claim 3, wherein associating the request with the stored identity data of the person includes associating, by the electronic apparatus, the read identity information with the stored identity data of the person.

5. The method of claim 1, further comprising:
initiating, by the electronic apparatus, the creation of an identity token for the person based on the identity data;
receiving, by the electronic apparatus, information regarding identity of the person from reading the identity token with an electronic token reader;
associating, by the electronic apparatus, the read identity information with the stored identity data of the person;
receiving, by the electronic apparatus, at least one new asserted attribute of the person; and
storing, by the electronic apparatus and in the electronic database, the at least one new asserted attribute in association with the stored identity data of the person.

6. The method of claim 1, further comprising querying, by the electronic apparatus, the one or more publishers of the one or more asserted attributes regarding the one or more asserted attributes of the person, wherein receiving confirmation of the one or more asserted attributes based on information received from one or more publishers of the one or more asserted attributes includes receiving, by the electronic apparatus, confirmation of the one or more asserted attributes from the one or more publishers in response to querying the one or more publishers of the one or more asserted attributes regarding the one or more asserted attributes of the person.

7. The method of claim 1, further comprising:
validating, by the electronic apparatus, the identity data of the person;
associating, by the electronic apparatus, the validation with the stored identity data of the person; and
storing, by the electronic apparatus and in the electronic database, an indication that the identity data of the person is validated.

8. A computer system for managing attributes of a person, comprising:
a processor;
a memory; and
a program comprising a plurality of instructions stored in the memory that are executed by the processor to:
receive identity data of a person;
receive one or more asserted attributes of the person;
store, in the memory, the identity data of the person in association with the one or more asserted attributes of the person;
receive confirmation of the one or more asserted attributes based on information received from one or more publishers of the one or more asserted attributes;
associate the confirmation with the one or more asserted attributes of the person; and
store, in the memory, an indication that the one or more asserted attributes are confirmed.

9. The computer system of claim 8, wherein the plurality of instructions further comprises instructions that are executed by the processor to:
receive, over a data network link, a request to confirm at least one asserted attribute of the person from a relying party;
associate the request with the stored identity data of the person;
determine, from the memory, whether the at least one asserted attribute is a confirmed attribute of the person; and
send, over a data network link, a communication regarding whether the at least one asserted attribute is a confirmed attribute of the person.

10. The computer system of claim 9, wherein the plurality of instructions further comprises instructions that are executed by the processor to:
initiate the creation of an identity token for the person based on the stored identity data; and
receive information regarding identity of the person from reading the identity token with an electronic token reader.

11. The computer system of claim 8, wherein the plurality of instructions further comprises instructions that are executed by the processor to:
initiate the creation of an identity token for the person based on the identity data;
receive information regarding identity of the person from reading the identity token with an electronic token reader;
associate the read identity information with the stored identity data of the person;
receive at least one new asserted attribute of the person; and
store, in the memory, the at least one new asserted attribute in association with the stored identity data of the person.

12. The computer system of claim 8, wherein the plurality of instructions further comprises instructions that are executed by the processor to:
query the one or more publishers of the one or more asserted attributes regarding the one or more asserted attributes of the person; and
receive confirmation of the one or more asserted attributes from the one or more publishers in response to querying the one or more publishers of the one or more asserted attributes regarding the one or more asserted attributes of the person.

13. The computer system of claim 8, wherein the plurality of instructions further comprises instructions that are executed by the processor to:
validate the identity data of the person;
associate the validation with the stored identity data of the person; and
store, in the memory, an indication that the identity data of the person is validated.

14. A computer program product for managing attributes of a person, the computer program product comprising:
at least one computer readable storage medium having computer readable program instructions embodied therewith, the computer readable program instructions, when read by a processor, being configured to:
receive identity data of a person;
receive one or more asserted attributes of the person;
store, in an electronic database, the identity data of the person in association with the one or more asserted attributes of the person;
receive confirmation of the one or more asserted attributes based on information received from one or more publishers of the one or more asserted attributes;
associate the confirmation with the one or more asserted attributes of the person; and
store, in the electronic database, an indication that the one or more asserted attributes are confirmed.

15. The computer program product of claim 14, wherein the computer readable program instructions, when read by a processor, are further configured to:
receive, over a data network link, a request to confirm at least one asserted attribute of the person from a relying party;
associate the request with the stored identity data of the person;
determine, from the electronic database, whether the at least one asserted attribute is a confirmed attribute of the person; and
send, over the data network link and to the relying party, a communication regarding whether the at least one asserted attribute is a confirmed attribute of the person.

16. The computer program product of claim 15, wherein the computer readable program instructions, when read by a processor, are further configured to:
initiate the creation of an identity token for the person based on the stored identity data; and
receive information regarding identity of the person from reading the identity token with an electronic token reader.

17. The computer program product of claim 16, wherein the computer readable program instructions, when read by a processor, are further configured to associate the read identity information with the stored identity data of the person.

18. The computer program product of claim 14, wherein the computer readable program instructions, when read by a processor, are further configured to:
initiate the creation of an identity token for the person based on the identity data;
receive information regarding identity of the person from reading the identity token with an electronic token reader;
associate the read identity information with the stored identity data of the person;
receive at least one new asserted attribute of the person; and
store, in the electronic database, the at least one new asserted attribute in association with the stored identity data of the person.

19. The computer program product of claim 14, wherein the computer readable program instructions, when read by a processor, are further configured to:
query the one or more publishers of the one or more asserted attributes regarding the one or more asserted attributes of the person; and
receive confirmation of the one or more asserted attributes from the one or more publishers in response to querying the one or more publishers of the one or more asserted attributes regarding the one or more asserted attributes of the person.

20. The computer program product of claim 14, wherein the computer readable program instructions, when read by a processor, are further configured to:
validate the identity data of the person;
associate the validation with the stored identity data of the person; and
store, in the electronic database, an indication that the identity data of the person is validated.
